(19) United States
(12) Patent Application Publication
(10) Pub. No.: US 2007/0171379 A1
(43) Pub. Date: Jul. 26, 2007

(54) Projection system of changing environment influence on display

(75) Inventors: Hun-Wei Chen, Padeh City (TW); Shih-Min Wu, Padeh City (TW); Chi-Neng Mo, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/339,688

(22) Filed: Jan. 26, 2006

(51) Int. Cl. G03B 21/26

(52) U.S. Cl. 353/37

(57) ABSTRACT

A system of changing environment influence on display is applied to a projection system. A reflection device is disposed between light management module and lenses module and configured for preventing environment light from the lenses module, so as to change the brightness of dark field and enhance contrast for display screen.

### BACKGROUND OF THE INVENTION

1. Field of the Invention

The present invention relates to a system of enhancing contrast of display screen for a projector, and more especially, to a projection system of changing environment influence on display screen.

2. Background of the Related Art

In recent years, the technology development has a tendency to combine the products of display and projector such as liquid crystal display projector, digital light processing (DLP), and liquid crystal on silicon (LCOS), etc.

Generally, the main components of a projector are light source module, light management module, and image projection module. Referring to FIG. 1, the conventional light management module includes the G/M (green/magenta) filter 110, R/B (red/blue) filter 112, polarization beam splitters (PBS) 114, 116, 118, 120, polarizer 123, green panel 122, red panel 124, and blue panel 126(blue panel), etc. The non-polarized light emitted from light source module inputs into the light management module, and then enters the lenses of image projection module. Thus, the stray light will be induced because that the light reflected by the lenses of image projection module will reflect back into the light plate of the light management module. The stray light leads to a phenomenon of light leakage in dark field, which will degrade the image contrast.

Conventionally, a quarter wave plate 127 is placed before the light plate of the light management module to change the stray light of light management module. Nevertheless, the stray light outside the light management module is also one factor of the light leakage in dark field. And it can't be improved by modifying the light management module.

### SUMMARY OF THE INVENTION

To change the light leakage in dark field induced by the environmental stray light for PBS, a component in one embodiment of this invention is provided. This component, which is placed between the light management module and the lenses of image projection module, may prevent the stray light reflected by the lenses of image projection module from entering into the light light management module or coming back into the lenses of image projection module.

To increase the output image contrast of display screen from a projector, a structure in one embodiment of this invention is provided. This structure for eliminating the light leakage in dark field utilizes a reflecting element placed between the light management module and the lenses of image projection module. The reflecting element reflects the stray light reflected by the lenses of image projection module in various directions to the area outside the lenses of image projection module, thereby reducing the dark field brightness.

To improve the output image contrast from a projector, a component in one embodiment of this invention is provided. This component for reducing the dark field brightness applies a reflecting lens placed before the light management module, which can prevent the environmental stray light from entering into the light plate of the light management module by reflecting the environmental stray light to the outside area of the light management module.

Accordingly, one embodiment of the present invention provides the projection system of preventing the environmental stray light. Reflecting means is placed between the light management module and the lenses module. The reflecting means is configured for preventing the environmental stray light coming from the lenses module from entering into the light management module.

### BRIEF DESCRIPTION OF THE DRAWINGS

FIG. 1 is a schematically diagram illustrating a light management module in accordance with the prior art.

FIG. 2 is a schematically diagram illustrating a system of blocking environment light in accordance with one embodiment of the present invention.

FIG. 3 is a schematically diagram illustrating a system of blocking environment light in accordance with the other embodiment of the present invention.

FIG. 4 is a schematically diagram illustrating a system of blocking environment light in accordance with another embodiment of the present invention.

### DETAILED DESCRIPTION OF THE INVENTION

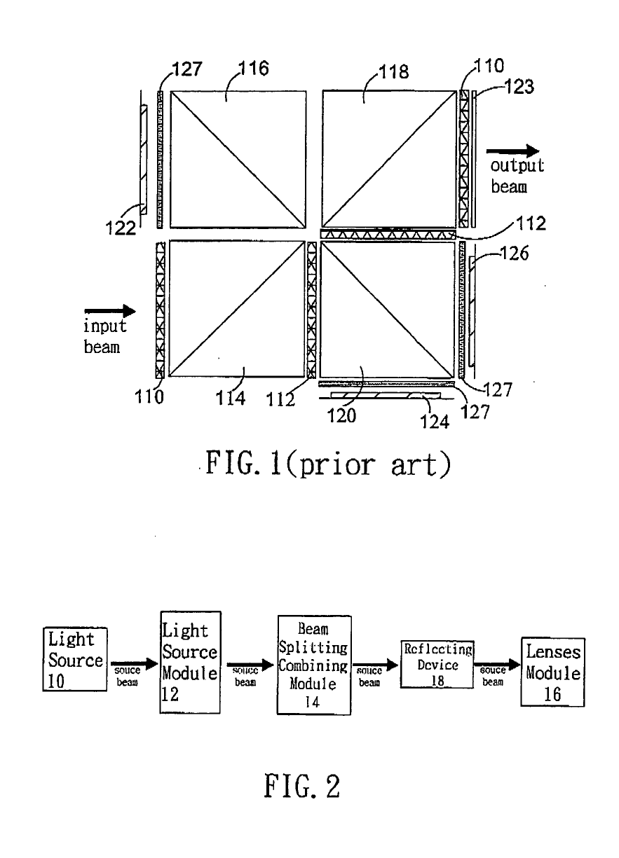

Referring to FIG. 2, light emitted from the light source 10 passes through the light source module 12 and the light management module 14, and then enters into the lenses module 16. According to the spirit of this invention, there is a reflecting device 18 placed between the light management module 14 and the lenses module 16. In the first embodiment, the reflecting device 18 may be one kind of a reflecting material attached to the light management module 14. For example, the reflecting material Ag or Al is coated on the surface of the last optical element through which the optical path is from the light source 10 to the lenses module 16 in the light management module 14. The optical component 20 may be, not limited to, a PBS, a filter, or a polarizer.

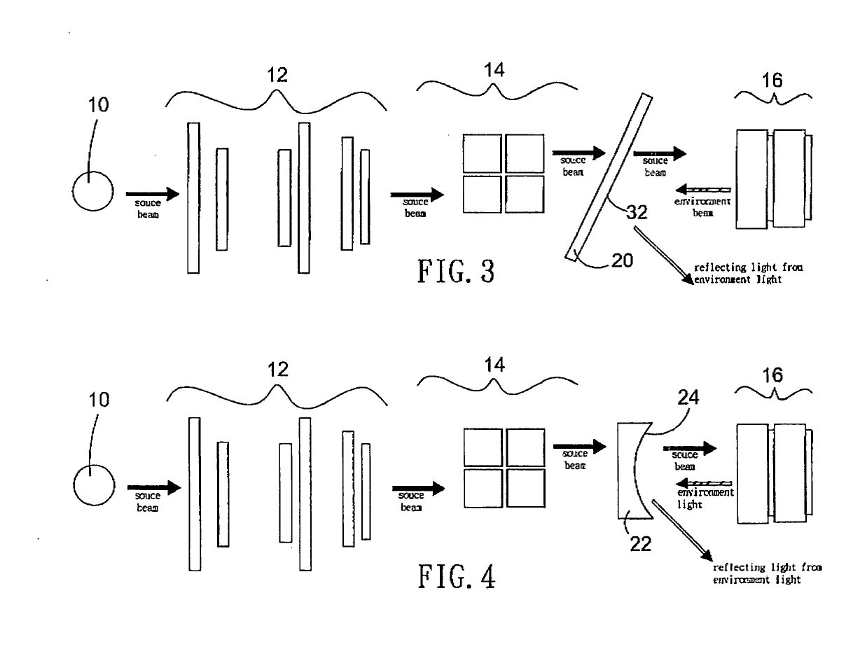

In the second embodiment, the reflecting device 18 may be one kind of a reflecting material attached on the lens surface that receives the light inputted from the light management module 14 in the lenses module 16. For example, the reflecting material Ag or Al is coated on the lens surface facing the light management module 14. Referring to the third embodiment in the FIG. 3, the reflecting device may be a reflecting lens 20 placed in the space between the light management module 14 and the lenses module 16. The lens surface coated by reflecting material is faced onto the lenses module 16 to prevent the incident light from the lenses module 16 from entering into the light management module 14. The preferred embodiment is the reflecting surface 32 of the reflecting lens 20 is tilted by an angle to the lenses module 16, which means that the reflecting lens 20 is placed unparallel to the lenses module 16. It may assure that the stray light reflected from the lenses module 16 does not incident back into the lenses module 16 after being reflected by the reflecting surface 32 of the reflecting lens 20. Especially for the range outside the applicable range of the lenses module 16, the incident angle and the reflection angle are not horizontal. It is to be understood that the applicable range of the lenses module 16 aforementioned is normally smaller than the diameter of lenses and located on the central area of lenses.

Referring to the fourth embodiment in the FIG. 4, the reflecting device is a concave lens 22 placed in the space between the light management module 14 and the lenses module 16. The lens surface 24 coated by reflecting material is faced onto the lenses module 16, so that the stray light from the lenses module 16 will be reflected to the outside area of the lenses module 16 after one or multi reflections by the lens surface 24. Furthermore, although the reflection coefficients of different reflecting materials are varied with the different light wavelengths, there is no limitation for the reflecting materials that may be adequately selected or combined by the different demands.

For projection equipment, the contrast is defined as the ratio of the brightness of white field to the brightness of dark field. The brightness of white field is dependent on the light source, such as its emitting efficiency and power, etc. Accordingly, although it is possible to increase the contrast by raising the brightness of white field, the contrast increase is limited owing to the aforementioned factors affecting the brightness of white field. On the other hand, it is also possible to increase the contrast by decreasing the brightness of dark field. According to the above description, one feature of this invention is to prevent or block the environmental stray light to decrease the brightness of dark field and so as to increase the contrast. Furthermore, observer is more sensitive to the contrast change than the brightness change of the screen. The spirit of this invention is to sacrifice little brightness to reward large contrast increase. Since, the setting of reflecting device may decrease little brightness, but increase large contrast and in such a way to elevate the display efficiency of screen.

Accordingly, one embodiment of the present invention provides the projection system of preventing the environmental stray light Reflecting means is placed between the light management module and the lenses module. The reflecting means is configured for preventing the environmental stray light coming from the lenses module from entering into the light management module. Another embodiment of the present invention provides the projection system of changing the brightness of dark field. A lenses module receives a beam output through said light management module from said light source. The position of the reflecting means results in the light management module placed between the light source and the reflecting means and is configured for reflecting light coming from the lenses module.

Although the present invention has been explained in relation to its preferred embodiment, it is to be understood that other modifications and variation can be made without departing the spirit and scope of the invention as hereafter claimed.

What is claimed is:

1. A projection system of changing environment influence on display, comprising:
a light management module;
a lenses module; and
reflecting means placed between said light management module and said lenses module, wherein said reflecting means is configured for preventing the environmental stray light coming from said lenses module from entering into said light management module.

2. The projection system of changing environment influence on display according to claim 1, wherein said reflecting means comprises a reflecting lens.

3. The projection system of changing environment influence on display according to claim 2, wherein the reflecting surface of said reflecting lens is faced onto but unparallel to the reflecting surface of said lenses module.

4. The projection system of changing environment influence on display according to claim 3, wherein said reflecting surface is a plane surface.

5. The projection system of changing environment influence on display according to claim 1, wherein said reflecting means comprises a reflecting concave lens.

6. The projection system of changing environment influence on display according to claim 1, wherein said reflecting means comprises a reflecting material attached on a surface of said lenses module, which said surface is faced onto said light management module.

7. The projection system of changing environment influence on display according to claim 1, wherein said reflecting means comprises a reflecting material attached on a surface of said light management module, which said surface is faced onto said lenses module.

8. A projection system of changing environment influence on display, comprising:
a light source;
a light management module;
a lenses module receiving a beam output through said light management module from said light source; and
reflecting means configured to place said light management module between said light source and said reflecting means, wherein said reflecting means is configured for reflecting light coming from said lenses module.

9. The projection system of changing environment influence on display according to claim 8, wherein said reflecting means comprises a reflecting concave lens.

10. The projection system of changing environment influence on display according to claim 8, wherein said reflecting means is a reflecting plane lens.

11. The projection system of changing environment influence on display according to claim 9, wherein said reflecting plane lens is tilted non-horizontally placed by an angle to said lenses module.

12. The projection system of changing environment influence on display according to claim 8, wherein said reflecting means comprises a reflecting material attached on an optical element of said light management module which is faced said lenses module.

13. The projection system of changing environment influence on display according to claim 8, wherein said reflecting means comprises a reflecting material attached on said lenses module and faced onto said lenses module.

14. The projection system of changing environment influence on display according to claim 8, wherein said light management module is composed of a plurality of optical components selected from the group consisting of polarization beam splitter, filter, polarizer, color plate, half wave plate, quarter wave plate.
